(19) United States
(12) Patent Application Publication
(10) Pub. No.: US 2016/0076798 A1
(43) Pub. Date: Mar. 17, 2016

(54) METHODS TO ENHANCE THE PERFORMANCE OF ELECTROCALORIC DIELECTRIC POLYMER

(71) Applicant: Nascent Devices LLC, State College, PA (US)

(72) Inventors: Qiming ZHANG, State College, PA (US); Ailan CHENG, State College, PA (US)

(21) Appl. No.: 14/800,458

(22) Filed: Jul. 15, 2015

Related U.S. Application Data
(60) Provisional application No. 62/050,613, filed on Sep. 15, 2014.

(51) Int. Cl. F25B 21/00; C09K 5/08

(52) U.S. Cl. CPC F25B 21/00; C09K 5/08; F25B 2321/001

(57) ABSTRACT

Cooling devices employing an EC polymer having an internal DC bias field are disclosed. The EC polymers include additional materials such as normal ferroelectric components with electric poling to establish an internal (built-in) DC bias field to enhance thermal characteristics of the EC polymers.

### CROSS-REFERENCE TO RELATED APPLICATION

This application claims the benefit of U.S. Provisional Application No. 62/050,613 filed Sep. 15, 2014 the entire disclosure of which is hereby incorporated by reference herein.

### TECHNICAL FIELD

The present disclosure is directed to cooling devices employing electrocaloric (EC) polymers. In particular, the present disclosure relates to cooling devices including EC polymers having an internal DC bias field and methods for making same.

### BACKGROUND

Electrocaloric effect provides an attractive means to realize high efficiency and environmentally friendly cooling technology, particularly if the effect is large. Electrocaloric effect (ECE) is a result of direct coupling between the thermal properties such as entropy and temperature and electric properties such as electric field and polarization in an insulation dielectric material, in which a change in the applied electric field induces a corresponding change in polarization, which in turn causes a change in the dipolar entropy Sₚ as measured by the isothermal entropy change ΔS in the dielectrics (entropy change is related to the heat Q=T ΔS, where T is the temperature). If the electric field change is carried out in an adiabatic condition, the dielectric will experience an adiabatic temperature change ΔT.

However, materials with small ECE (ΔT<2 K) reported in the past makes these materials unpractical for cooling devices. Recently, it was discovered that in a class of polar-dielectric polymers, a very high electrocaloric effect can be achieved (Neese, et al., Large Electrocaloric Effect in Ferroelectric Polymers Near Room Temperature. Science, 321, 821-823 (2008); Lu, et al., Organic and Inorganic Relaxor Ferroelectrics with Giant Electrocaloric Effect, Appl. Phys. Lett. 97, 162904 (2010); Li, et al., Tunable Temperature Dependence of Electrocaloric Effect in Ferroelectric Relaxor P(VDF-TrFE-CFE) Terpolymer, Appl. Phys. Lett. 99, 052907 (2011)). Accordingly, there is a continuing need to improve the electrocaloric effect of electrocaloric polymers and use of such polymers for cooling devices.

### SUMMARY OF THE DISCLOSURE

Advantages of the present disclosure include cooling devices, such as air conditioning, refrigerating, and heat pumps, comprising EC polymers with an internal DC bias field. Such EC polymers can have improved ΔT and ΔT/ΔE characteristics.

These and other advantages are satisfied, at least in part, by a cooling device comprising a refrigerant which includes an electrocaloric polymer (EC polymer), wherein the EC polymer has an internal DC bias field. Advantageously, the cooling device can transfer heat from one temperature to another temperature, in particular from a lower temperature T_{c} to a higher temperature Tₕ (Tₕ>T_{c}).

EC polymers which have internal (built-in) DC bias field can be in the form of polymer layers, blends, or composites, e.g., nanocomposites, with high electrocaloric effect (ECE). For example, the enhanced EC polymer can include, in the form of a blend or arranged in layers: (i) at least one high EC polymers and (ii) at least one other polymer, e.g. a normal ferroelectric polymer, which can provide an internal DC bias field. Alternatively, the enhanced EC polymer can include: (i) at least one high EC polymers and (ii) at least one ceramic material which can provide an internal DC bias field.

High EC polymers can include, for example, a terpolymer of formula of P(VDF_{1-x-y}—R¹ₓ—R²_{y}), where R¹ is TrFE or TFE or combinations thereof, and R² is CFE, CTFE, CDFE, HFP, HFE, VDC, VF, TFE or combinations thereof. The variable x is in the range 0.01 to 0.49, and y is in the range from 0.01 to 0.15. The at least one polymer or one ceramic materials which can provide material internal DC bias field include, for example, a copolymer of formula of P(VDF_{1-z}-TrFE_{z}), where z is in the range from 0.1 to 0.5, and preferably 0.2 to 0.45, or P(VDF_{1-z}-TFE_{z}), where z is in the range from 0.1 to 0.4, and preferably from 0.15 to 0.3, or BaTiO3 and its derivatives.

Another aspect of the present disclosure includes a process of forming an electrocaloric polymer (EC polymer) having an internal DC bias field. The process comprising subjecting an EC polymer with an additional material to an electric field to polarize the additional material and form an internal DC bias field for the EC polymer. The EC polymer with the additional can be subjected to a Corona poling at a voltage higher than 1,000 volts at a temperature of greater than 30° C. Alternatively, the EC polymer with the additional can be subjected to an electric field higher than 100 MV/m and at a temperature greater than 30° C. for more than one minute.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent similar elements throughout and wherein:

FIGS. 1(a) and 1(b) are charts illustrating electrocaloric effect over electric field of polymers. FIG. 1(a) is a chart showing ECE induced adiabatic temperature change ΔT in a P(VDF-TrFE-CFE) ferroelectric relaxor terpolymer (Li et al. Appl. Phys. Lett. 99, 052907 (2011)); FIG. 1(b) is a chart showing the increased ΔT for the same ΔE for an EC polymer (in (a)) with a built-in DC bias field E_{Mater} (E_{Mater}=40 MV/m, in the example). The figures show that without internal DC bias field of 40 MV/m, a ΔE=20 MV/m will generate a delta(T)=40 (in arb. Unit). With an internally built-in DC bias field E_{Mater}=40 MV/m, a ΔE=20 MV/m will generate a delta(T)=200 (in arb. Unit), 5 times higher.

FIG. 2 illustrates polarization-electric field loops at room temperature for a ferroelectric relaxor terpolymer and its comparison with that of a normal ferroelectric P(VDF-TrFE).

FIGS. 3(a) and 3(b) illustrate EC polymers with an internal DC bias field. FIG. 3(a) is a schematic of a multilayer EC polymer with an internal DC bias field provided by alternating layers of EC polymers (relaxor terpolymer) and normal ferroelectric polymers. In general, the thickness of the EC polymer layer should be about 10 times of that of the normal ferroelectric polymer layer. FIG. 3(b) is a schematic drawing of aligned dipoles in P(VDF-TrFE) layer 320 (which act as an internal (built-in) DC bias field in the EC polymer) to induce a partial orientation of dipoles in the EC (relaxor) ferroelectric polymer 310.

FIG. 4 is a schematic illustration of a blend in which a normal ferroelectric polymer is dispersed in the EC polymer matrix or a nanocomposite in which nano-particles of a normal ferroelectric ceramic are dispersed in the EC polymer matrix.

FIGS. 5(a) and 5(b) are charts. FIG. 5(a) shows the increased polarization response in an enhanced EC polymer, which is a poled blend of a relaxor P(VDF-TrFE-CFE)/P(VDF-TrFE) (90/10 wt %). The polarization is significantly increased in the whole voltage range when the blend is poled and the operation field (applied field) is along the poling direction. FIG. 5(b) shows the increased polarization under applied field of 100 MV/m in the poled blend of a relaxor P(VDF-TrFE-CFE)/P(VDF-TrFE) 90/10 wt % vs. the composition z of P(VDF_{z}-TrFE_{1-z}). The internal, built-in DC bias field depends on the P(VDF-TrFE) composition. For the P(VDF_{z}-TrFE_{1-z}) with the composition with z>0.9 in the blends, the polarization level is reduced compared with pure terpolymer.

FIG. 6 shows the increased ECE (ΔT) response in a relaxor P(VDF-TrFE-CFE)/P(VDF-TrFE) (65/35 mol %) 90/10 wt % blend, due to a built-in, internal DC bias field, vs. the applied electric field. That is, ΔT of the poled blend (enhanced EC polymer) is higher than that of the blend, especially at low electric field, such as at below 50 MV/m applied electric fields.

### DETAILED DESCRIPTION OF THE DISCLOSURE

The present disclosure is directed to cooling devices, including but not limited to heat pumps, refrigerators, air conditioning, climate control systems, etc., that include one or more EC polymers with an internal DC bias field as a refrigerant, e.g. operably included in the device to transfer heat such as to transfer heat from low temperature load to high temperature heat sink. Advantageously, EC polymers with an internal DC bias field have a significant temperature/entropy change upon the application and removal of electric field or voltage.

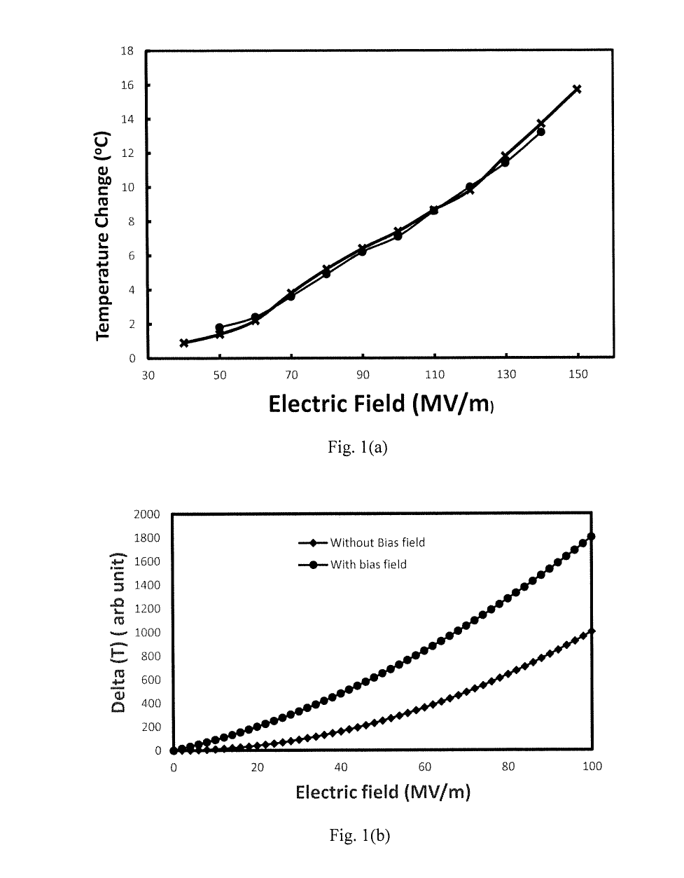

EC polymers can have enhanced electrocaloric characteristics by including materials therewith or therein that create an internal DC bias field. In polymers, in which a large ECE was achieved (see FIG. 1(a) as an example), the EC response is low when the applied field is low. For example, when the applied electric field is increased from 0 to 40 MV/m (ΔE=40 MV/m), the temperature change (ΔT) of the polymer due to the ECE, is less than 0.8 K. On the other hand, increasing the electric field from 40 MV/m to 80 MV/m (ΔE=40 MV/m), ΔT becomes>4.2 K (ΔT=5 K when the E-field is increased from 0 to 80 MV/m). The EC polymers measured in FIG. 1(a) were P(VDF-TrFE-CFE) relaxor terpolymer.

If the EC polymer has an internal DC bias field equal to 40 MV/m, a change of the applied field from 0 to 40 MV/m will result in a ΔT=4.2 K, rather than a value lower than 0.8 K. 4.2K is a significant improvement in the EC performance. For practical cooling devices, a lower operation electric field is preferred if the same ΔT can be induced. In other words, a large ΔT and ΔT/ΔE are preferred for practical cooling devices.

For example and as shown in FIG. 1(b), ΔT can increase significantly for the same AE for an EC polymer (in FIG. 1(a)) but with a built-in DC bias field (E_{Mater}=40 MV/m, in the example). The EC polymer with an internal DC bias field can be prepared by blending an EC polymer with a normal ferroelectric polymer such as P(VDF-TrFE). FIGS. 1(a) and 1(b) show that without internal DC bias field at 40 MV/m, a ΔE=20 MV/m will generate a delta(T)˜40 (in arb. Unit). With an internally built-in DC bias field E_{Mater}=40 MV/m, a ΔE=20 MV/m will generate a delta(T)˜200 in arb. Unit).

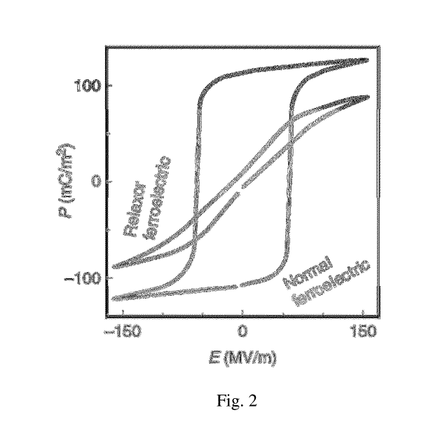

The reason for the low EC response at low electric field for the EC polymers of ferroelectric relaxors such as (P(VDF-TrFE-R), (P(VDF-TrFE): poly(vinylidene fluoride-trifluoroethylene) where R can be CFE (chlorofluoroethylene), CTFE (chlorotrifluoroethylene), or HFP (hexafluoropropylene)), is the nature of the polymers which have near zero polarization P when the applied field E=0, as illustrated in FIG. 2. From thermodynamic theory, the ECE such as ΔT and ΔS are proportional to the P2 (the square of the polarization).

ΔT and ΔS∝P² (1)

If P is linearly proportional to E (which is a good approximation for FIG. 2 when E<150 mV/m), ΔT and ΔS will also be proportional to the square of E,

ΔT=A E², (2)

Where A is a coefficient. As E is increased from 0 to 40, ΔT is 1600 A. If there is an internal DC bias field E_{Mater} in the polymer, as the external field is increased from 0 to 40, ΔT will be A (6400−1600)=4800 A, which is 3 times higher than that without the internal DC bias field. In the practical situation, the degree of enhancement may vary, depending on the polymers. As shown in FIG. 1(a), ΔT is 0.8 C when ΔE is from 0 to 40 MV/m (or ΔE from 40 MV/m to 0, in which ΔT is −0.8 C). On the other hand, ΔT is 4.2 C when ΔE is from 40 MV/m to 80 MV/m or ΔE from 80 MV/m to 40 MV/m, ΔT is −4.2 C).

However, by designing EC polymers with built-in, internal DC bias fields (in the material) E_{Mater} so that when the external field is varied between 0 to E_{H} (for example, E_{H}=40 MV/m), it is equivalent to a “real electric field change” from E_{Mater} to E_{Mater}+E_{Mater}+E_{H}, thus leading to a large ΔT and ΔT/ΔE. FIGS. 1(a) and 1(b) illustrate the enhanced the EC response of the EC polymer with an internal DC bias field.

In one aspect of the present disclosure, EC polymers which have internal (built-in) DC bias field are employed in cooling devices as a refrigerant. Such enhanced EC polymers exhibit a higher EC response for a given applied electric field compared with the same ferroelectric relaxor without the internal DC bias field. The enhanced EC polymers can be in the form of polymer layers, blends, or composites, e.g., nanocomposites, with high electrocaloric effect (ECE). For example, the enhanced EC polymer can include, in the form of a blend or arranged in layers: (i) at least one high EC polymers and (ii) at least one other polymer which can provide an internal DC bias field. Alternatively, the enhanced EC polymer can include: (i) at least one high EC polymers and (ii) at least one ceramic material which can provide an internal DC bias field.

EC polymers can have enhanced electrocaloric characteristics by including materials therewith or therein that create an internal DC bias field. The additional materials can be polarized by subjecting the EC polymer with such materials with an electric field to polarize the additional material. For example the EC polymer can be pre-treated under an electric field higher than 100 MV/m at an elevated temperature (e.g., >30° C.), preferably >50°0 C., and more preferably >80° C., for more than one minute, or preferably more than 10 minutes. Advantageously, the EC polymer can have a polarization of at least 5% higher after subjected to poled when the operation field is along the direction of electrical poling field.

In an aspect of the present disclosure, an EC polymers having an internal DC bias field which can be formed by subjecting the EC polymer with an additional material to an electric field to polarize the additional material and form an internal DC bias filed for the EC polymer. The EC polymer with the additional material can be prepared by combining at least one high EC polymers with an additional material (e.g., at least one other polymer which can provide an internal DC bias field and/or at least one ceramic material which can provide an internal DC bias field). In an embodiment of the present application, the electric-field-treatment (poling) of the EC polymer in the form of multilayer films, blends or composites includes subject the EC polymer to a Corona poling at a voltage higher than 1,000 volts at an elevated temperature (e.g., >30° C.), preferably higher than 50° C. Advantageously, the EC polymer can have a polarization of at least 5% higher than an EC polymer that was not subjected to an electrical-field-pre-treatment when the operation field is along the direction of electrical poling field, and preferably, the induced polarization is 10% higher than without electrical-field-pre-treatment when the operation field is along the direction of electrical poling field.

A high EC polymer can include, for example, a terpolymer of formula of P(VDF_{1-x-y}—R¹ₓ—R²_{y}), where R¹ is selected from trifluoroethylene (TrFE) or tetrafluoroethylene (TFE) or mixtures thereof, and R² selected from chlorofluoroethylene (CFE), chlorotrifluoroethylene (CTFE), chloro-difluoroethylene (CDFE), hexafluoropropylene (HFP), hexafluoroethylene (HFE), vinylidene chloride (VDC), vinyl fluoride (VF), TFE, and combinations thereof. The variable x is in a range of 0.01 to 0.49, e.g., x can be 0.1 to 0.49, and y is in a range of 0.01 to 0.15. Such terpolymer include P(VDF_{1-x-y}-TrFEₓ-CFE_{y}), P(VDF_{1-x-y}-TrFEₓ-CTFE_{y}), P(VDF_{1-x-y}-TrFEₓ-HFP_{y}), P(VDF_{1-x-y}-TFEₓ-CTFE_{y}), and P(VDF_{1-x-y}-TFEₓ-CFE_{y}) (0.01<y<0.15 and 0.10<x<0.49) which exhibit significant EC responses.

Preferred terpolymers include polyvinylidene fluoride-trifluoroethylene-chlorofluoroethylene (P(VDF-TrFE-CFE)), polyvinylidene fluoride-trifluoroethylene-chlorodifluoroethylene (P(VDF-TrFE-CDFE)), polyvinylidene fluoride-trifluoroethylene-chlorotrifluoroethylene (P(VDF-TrFE-CTFE)), polyvinylidene fluoride-trifluoroethylene-hexafluoropropylene (P(VDF-TrFE-HFP)), polyvinylidene fluoride-trifluoroethylene-tetrafluoroethylene (P(VDF-TrFE-TFE)), polyvinylidene fluoride-trifluoroethylene-vinylidene chloride P(VDF-TrFE-VDC), polyvinylidene fluoride-trifluoroethylene-vinyl fluoride P(VDF-TrFE-VF), polyvinylidene fluoride-trifluoroethylene-hexafluoroethylene P(VDF-TrFE-HFE), polyvinylidene fluoride-tetrafluoroethylene-chlorofluoroethylene (P(VDF-TFE-CFE)), polyvinylidene fluoride-tetrafluoroethylene-chlorodifluoroethylene (P(VDF-TFE-CDFE)), polyvinylidene fluoride-tetrafluoroethylene-chlorotrifluoroethylene (P(VDF-TFE-CTFE)), polyvinylidene fluoride-tetrafluoroethylene-hexafluoropropylene (P(VDF-TFE-HFP)), polyvinylidene fluoride-tetrafluoroethylene-hexafluoroethylene P(VDF-TFE-HFE), polyvinylidene fluoride-tetrafluoroethylene-vinylidene chloride P(VDF-TFE-VDC), polyvinylidene fluoride-tetrafluoroethylene-vinyl fluoride P(VDF-TFE-VF), etc. These terpolymers have monomer units in ratios defined for the variables x and y provided in the various embodiments of the present disclosure.

The other polymer which can provide an internal DC bias field includes a copolymer, such as P(VDF_{1-z}-TrFE_{z}), where z is in a range of 0.1 to 0.5, and preferably 0.2 to 0.45, or P(VDF_{1-z}-TFE_{z}), where z is in the range from 0.1 to 0.4, and preferably from 0.15 to 0.3.

In one aspect of the present disclosure, an enhanced EC polymer can be formed by arranging a multilayer structure including alternating layers of relaxor terpolymer and normal ferroelectric polymers. In such a multilayered structure, each pair of relaxor terpolymer and normal ferroelectric polymer can be referred to as a bilayer. The multilayered structure can include any number of bilayers and can include a top and/or bottom layer of either the relaxor terpolymer and/or the normal ferroelectric polymer. Since the ECE of the normal ferroelectric is typically smaller than that in the relaxor ferroelectric terpolymer, it is preferred that the volume fraction of the normal ferroelectric polymer is low, such as below 15%, e.g., less than about 10%, so that the reduction of ECE in the multilayer structure will be small.

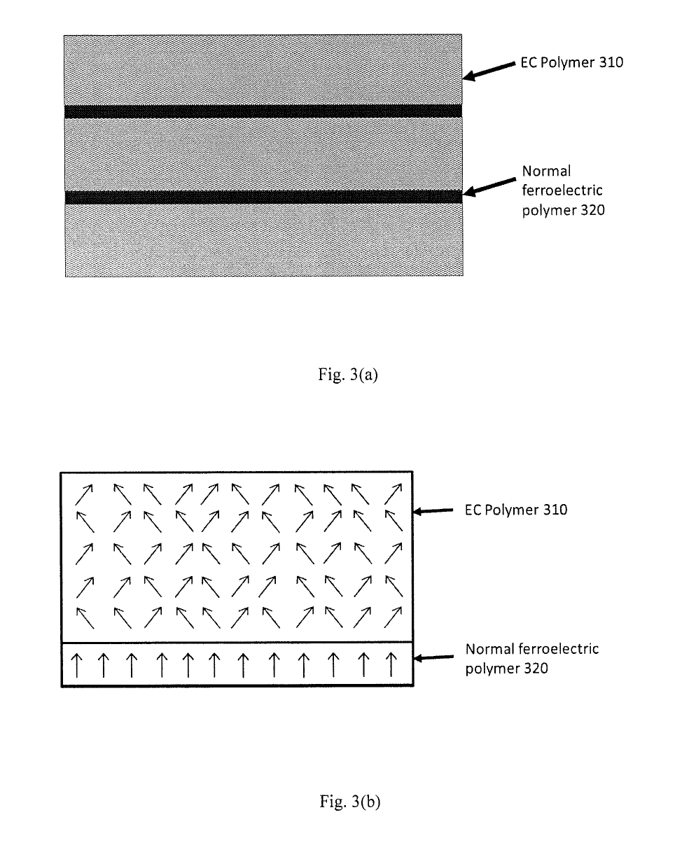

In an embodiment of the present disclosure, an enhanced EC polymer can be formed by arranging a multilayer structure including alternating layers of relaxor terpolymer P(VDF_{1-x-y}—R¹ₓ—R²_{y}) and normal ferroelectric polymers P(VDF_{z}—R_{1-z}) where R¹, R² and x and y are as defined above, including the various embodiments thereof and z is in the range from 0.5 to 0.9. For the normal ferroelectric P(VDF_{z}—R_{1-z}), R is TrFE or TFE and z is in the range of 0.5 to 0.9 when R is TrFE, and z is in the range of 0.6 to 0.9 when R is TFE. By poling such multilayered structures under external electric fields, the normal ferroelectric polymer in the structure can be poled to establish an internal DC bias field. For example, in the embodiment shown in FIG. 3(a), relaxor EC polymer layers 310 such as P(VDF-TrFE-CFE) layers and a normal ferroelectric polymer layers 320 such as P(VDF-TrFE) layers are arranged alternatively. In the P(VDF-TrFE) normal ferroelectric polymer, the dipoles can be highly aligned along the direction of a poling field after the electric field poling so that the polymer exhibits a remnant polarization. FIG. 2 shows a polarization-electric field loop of a P(VDF-TrFE) normal ferroelectric polymer. These aligned dipoles (and the remnant polarization) can induce some degree of the dipole alignment in the adjacent layers of the relaxor polymer so that even without external applied electric fields, the relaxor terpolymer will have a non-zero polarization as illustrated in FIG. 3(b). In other words, the normal ferroelectric layer comprised of P(VDF-TrFE) will generate an internal DC bias field so that the relaxor polymer will have some polarization P when there is no external electric field applied.

Due to the charge neutrality, the polarization P in the relaxor polymer layer (EC polymer) should be the same as that in the normal ferroelectric P(VDF-TrFE) layer. Hence the DC poling of and establishment of remnant polarization in the normal ferroelectric P(VDF-TrFE) layer will induce a partial dipole ordering the EC polymer. Because the random dipoles in the EC (relaxor) polymer layer may affect (and reduce) the polarization alignment in the normal ferroelectric P(VDF-TrFE) polymer at the interface region, the remnant polarization in the P(VDF-TrFE) copolymers in the multilayer structure of FIG. 3 may be reduced (or may not reach the level when there is no relaxor polymer layer. This remnant polarization level of the P(VDF-TrFE) layer will depend on the copolymer composition and also the relative thickness ratio between the EC (relaxor) polymer and the normal ferroelectric polymer.

Since the ECE of the normal ferroelectric P(VDF-TrFE) copolymer is much smaller than that in the relaxor ferroelectric terpolymer such as P(VDF-TrFE-CTFE), it is preferred that their volume fraction should be low, for example, below 15%, e.g., less than about 10%, so that the reduction of ECE in the EC multilayer will be small. Assuming the ECE of the P(VDF-TrFE) copolymer is zero, the isothermal entropy change AS of the multilayer, due to the ECE, will be reduced from that of the pure relaxor polymer ΔS_{poly},

ΔS_{multiL}=ΔS_{poly} (1−f) (3)

Where f is the volume fraction of P(VDF-TrFE). When f is small such as <0.1, ΔS_{multiL} is more than 90% of ΔS_{poly}.

The enhanced EC polymer in the form of a multilayer structure including alternating layers of relaxor terpolymer and normal ferroelectric polymers can exhibit an ECE temperature change ΔT>3 degrees, e.g., an ECE temperature change ΔT>4 degree, induced under an applied electric field less than 50 MV/m.

In another aspect of the present disclosure, an EC polymer with internal DC bias field can be formed by polymer blending one or more relaxor terpolymers with one or more normal ferroelectric polymers. From the basic electrostatic consideration, the internal DC bias field from the normal ferroelectric polymer component can also be achieved by a polymer blend approach in which a low vol % of the normal ferroelectric polymer is blended into the EC (relaxor) ferroelectric polymer. Since the ECE of the normal ferroelectric is typically smaller than that in the relaxor ferroelectric terpolymer, it is preferred that the volume fraction of the normal ferroelectric polymer is low, such as below 15 volume %, preferably lower than 10 volume %.

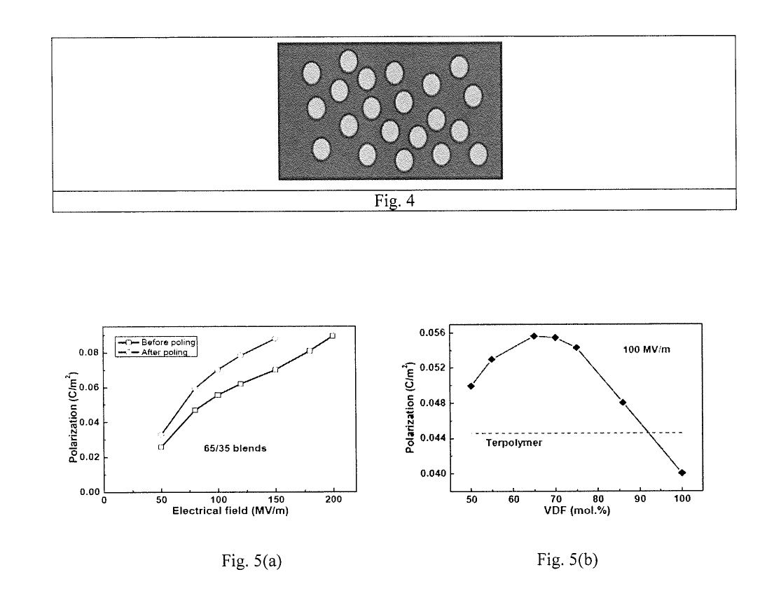

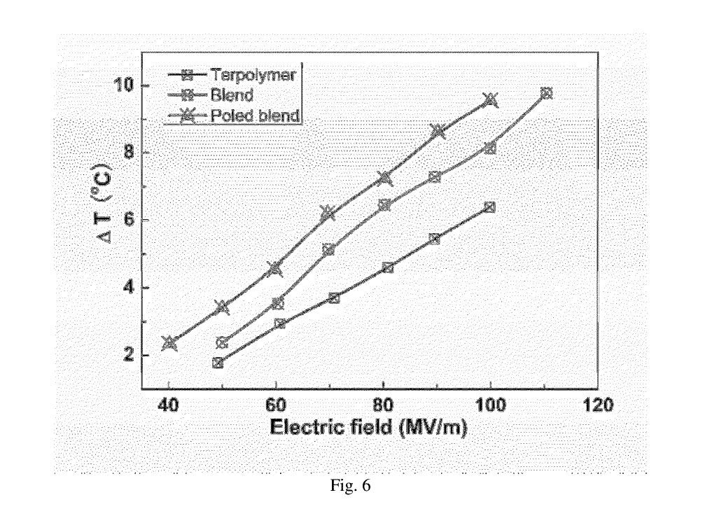

For example and as shown in FIG. 4, a normal ferroelectric polymer, e.g., P(VDF-TrFE), can be dispersed in a relaxor terpolymer matrix, e.g., P(VDF-TrFE-CFE). The dispersed ferroelectric polymer is preferably sized in the nanometer range. In these blend systems, by poling the blends under external electric fields, the normal ferroelectric polymer in the blend may be poled to establish an internal DC bias field in the blend, analogous to that in the multilayer case (FIG. 3(b)). Since the EC response of the normal ferroelectric polymer is much lower than the relaxor (EC) polymer, the weight % of the normal ferroelectric polymer in the blend should not be high, typically below 15 wt %, preferably at or below 10 wt%. (The density of the relaxor (EC) terpolymer and normal ferroelectric copolymer is nearly the same, hence, the wt % is nearly the same as the volume %).

Because the random dipoles in the EC (relaxor) polymer matrix will affect (and reduce) the polarization alignment in the normal ferroelectric P(VDF-TrFE) polymer, the remnant polarization in the P(VDF-TrFE) copolymers in the blend of FIG. 4 may be reduced. This remnant polarization level of the P(VDF-TrFE) in the blends will depend on the copolymer composition and also the vol % of the copolymer in the blend. As shown in FIG. 5(b), the polarization of the blends (10 wt % of P(VDF-TrFE) copolymer in the blends) measured at 100 MV/m after the poling is higher than that of the neat terpolymer (the dashed line) when the copolymers in the VDF/TrFE composition range from 50/50 mol % to 90/10 mol % are used in the blends.

Another embodiment of this disclosure is the poling the blends under external electric fields to establish DC field biased polarization. For example, by subjecting the blends or multilayer films under a 100 MV/m or higher electric fields for extended time, such as several minutes, and preferably at an elevated temperatures above room temperature to establish DC bias field in the material. The polarization level of the blends or multilayer films can be enhanced when the operation field is along the same direction as that of the poling field, compared with that without electric field poling as shown in FIG. 5. Since the ECE is proportional to the square of the polarization, the ECE in these DC field biased blends and multilayer films can be improved when the operation field is along the same direction of the original poling field. On the other hand, it is expected that the polarization level is reduced if the operation field is in the opposite direction to that of the poling field.

In an embodiment of the present disclosure, an enhanced EC polymer can be formed by combining a high EC polymer with one or more ferroelectric ceramic materials which can provide an internal DC bias. Such ceramic materials include BaTiO₃, Ba(TiR₁₋ₓ)O₃ (modified BaTiO₃) where R includes but not limited to Zr and Sn, and x <0.2, (Baₓ-Sr₁₋ₓ)TiO₃ where x <0.15, and Pb(ZrTi)O₃ derivatives thereof. The ceramic materials can be in the form of nano-particles, i.e., the size of the normal ferroelectric ceramic particles is less than about 0.1 μm, preferably the size of the normal ferroelectric ceramic particles is less than about 0.01 μm. The volume fraction of the ceramic materials is preferably less than about 20 volume %, e.g., less than about 10 vol %, and more preferably, less than about 5 vol %. The internal (built-in) DC bias field of the composite can be established by poling the composites by applying a DC electric field of higher than 100 MV/m at an elevated temperature (>30° C.), preferably higher than 40° C., and more preferably high than 60° C.

Only the preferred embodiment of the present invention and examples of its versatility are shown and described in the present disclosure. It is to be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific substances, procedures and arrangements described herein. Such equivalents are considered to be within the scope of this invention, and are covered by the following embodiments:

1. A cooling device comprising a refrigerant which includes an electrocaloric polymer (EC polymer), wherein the EC polymer has an internal DC bias field.

2. The device of claim 1, wherein the EC polymer is arranged in a multilayered structure including alternating layers of one or more relaxor terpolymers and one or more normal ferroelectric polymers.

3. The device of claim 1, wherein the EC polymer is a blend including one or more normal ferroelectric polymers dispersed in one or more relaxor terpolymers.

4. The device of claim 1, wherein the EC polymer is a composite of at least one relaxor terpolymers and at least one normal ferroelectric ceramic.

5. The device of claim 4, wherein the at least one normal ferroelectric ceramic is BaTiO₃.

6. The device of any one of claim 2, wherein the relaxor terpolymer has the formula of P(VDF_{1-x-y}—R¹ₓ—R_{2-y}), wherein VDF is vinylidene fluoride, R¹ is selected from trifluoroethylene (TrFE) and/or tetrafluoroethylene (TFE), R² is selected from chlorofluoroethylene (CFE), chlorotrifluoroethylene (CTFE), chloro-difluoroethylene (CDFE), hexafluoropropylene (HFP), hexafluoroethylene (HFE), vinylidene chloride (VDC), vinyl fluoride (VF), TFE, and combinations thereof, x is in a range of 0.01 to 0.49, and y is in a range of 0.01 to 0.15.

7. The device of any one of claim 2, wherein the normal ferroelectric polymer has the formula of P(VDF_{1-z}—R_{z}), wherein VDF is vinylidene fluoride, R is selected from trifluoroethylene (TrFE) and/or tetrafluoroethylene (TFE), and z is in a range of 0.1 to 0.5 when R is TrFE and z is in a range of 0.1 to 0.4 when R is TFE.

8. The device of any one of claim 2, wherein a volume percentage of the normal ferroelectric polymer is less than 15%.

9. The device of any one of claim 1, wherein the EC polymer exhibits an electrocaloric effect temperature change (ΔT) of greater than 3 degrees induced under an applied electric field less than 50 MV/m.

10. The device of any one of claim 1, wherein the EC polymer is poled by subjecting the EC polymer under an electric field higher than 100 MV/m and at a temperature greater than 30° C. for more than one minute.

11. The device of claim 10, wherein the EC polymer has a polarization at least 5% higher after subjected to poled when the operation field is along the direction of electrical poling field.

12. A process of forming an electrocaloric polymer (EC polymer) having an internal DC bias field, the process comprising subjecting an EC polymer with an additional material to an electric field to polarize the additional material and form an internal DC bias filed for the EC polymer.

13. The process of claim 12, comprising subjecting the EC polymer with the additional to a Corona poling at a voltage higher than 1,000 volts at a temperature of greater than 30° C.

14. The process of claim 12, comprising subjecting the EC polymer with the additional to an electric field higher than 100 MV/m and at a temperature greater than 30° C. for more than one minute.
